(19) United States
(12) Patent Application Publication
(10) Pub. No.: US 2025/0316885 A1
(43) Pub. Date: Oct. 9, 2025

(54) MICROSTRIP ANTENNA, WIRELESS TAG COMMUNICATION DEVICE, AND SHEET PROCESSING DEVICE

(71) Applicant: Toshiba Tec Kabushiki Kaisha, Tokyo (JP)

(72) Inventor: Yuki KAWASAKI, Numazu (JP)

(73) Assignee: Toshiba Tec Kabushiki Kaisha, Tokyo (JP)

(21) Appl. No.: 19/068,529

(22) Filed: Mar. 3, 2025

(30) Foreign Application Priority Data
Apr. 4, 2024 (JP) 2024-060593

(51) Int. Cl. H01Q 1/22; G03G 15/00; G03G 21/16; H01Q 9/04

(52) U.S. Cl. CPC H01Q 1/2216; G03G 15/50; G03G 15/6588; G03G 21/1657; H01Q 9/0407

(57) ABSTRACT

According to an embodiment, a microstrip antenna includes a radiating element. The radiating element includes a first radiation area including a first major axis which is a major axis parallel to a first direction and a first minor axis which is a minor axis perpendicular to the first major axis, and a second radiation area including a second major axis which is a major axis parallel to the first direction and longer than the first major axis and a second minor axis which is a minor axis perpendicular to the second major axis. A length of the second minor axis is shorter than a length of the first minor axis.

### CROSS-REFERENCE TO RELATED APPLICATION

This application is based upon and claims the benefit of priority from Japanese Patent Application No. 2024-060593, filed on Apr. 4, 2024, the entire contents of which are incorporated herein by reference.

### TECHNICAL FIELD

Embodiments described herein relate generally to a microstrip antenna, a wireless tag communication device, and a sheet processing device.

### BACKGROUND

An image forming device may form an image on a sheet provided with a wireless tag such as a radio frequency identifier tag (RFID). Such an image forming device may exchange information with the wireless tag on the sheet via radio waves using a microstrip antenna provided with multiple types of radiating elements capable of transmitting and receiving radio waves. However, the efficiency of energy conversion from electrical signals to radio waves by microstrip antennas was not always good.

### DESCRIPTION OF THE DRAWINGS

FIG. 1 is a diagram illustrating an example of an image forming device according to an embodiment;

FIG. 2 is a functional block diagram of the image forming device, according to an embodiment;

FIG. 3 is a diagram illustrating an example of a position where a sheet can be present in the image forming device, according to an embodiment;

FIG. 4 is a diagram illustrating an example of a relationship between an arrangement of wireless tags on a sheet and a conveyance direction of the sheet, according to an embodiment;

FIG. 5 is a diagram illustrating an example of a configuration of a wireless tag communication device, according to an embodiment;

FIG. 6 is a diagram illustrating an example of a side view of a configuration of an antenna, according to an embodiment;

FIG. 7 is an explanatory diagram illustrating an example of a radiating element shape, according to an embodiment;

FIG. 8 is a diagram illustrating an example of a result of an experiment using the antenna including the radiating element, according to an embodiment;

FIG. 9 is an explanatory diagram illustrating an example of a radiating element shape of a radiating element in a modification, according to an embodiment; and

FIG. 10 is a diagram illustrating an example of a result of an experiment using the antenna including the radiating element, according to an embodiment.

### DETAILED DESCRIPTION

The problem to be solved by the present disclosure is to provide a microstrip antenna, a wireless tag communication device, and a sheet processing device that can improve the efficiency of energy conversion from an electrical signal to radio waves.

In general, according to an embodiment, a microstrip antenna includes a radiating element. The radiating element includes a first radiation area including a first major axis which is a major axis parallel to a first direction and a first minor axis which is a minor axis perpendicular to the first major axis, and a second radiation area including a second major axis which is a major axis parallel to the first direction and longer than the first major axis and a second minor axis which is a minor axis perpendicular to the second major axis. A length of the second minor axis is shorter than a length of the first minor axis.

Hereinafter, a wireless tag communication device and a sheet processing device according to the embodiment will be described with reference to the drawings. In the following description, components having the same or similar functions are designated by the same reference numerals. In addition, description of duplicated configurations may be omitted.

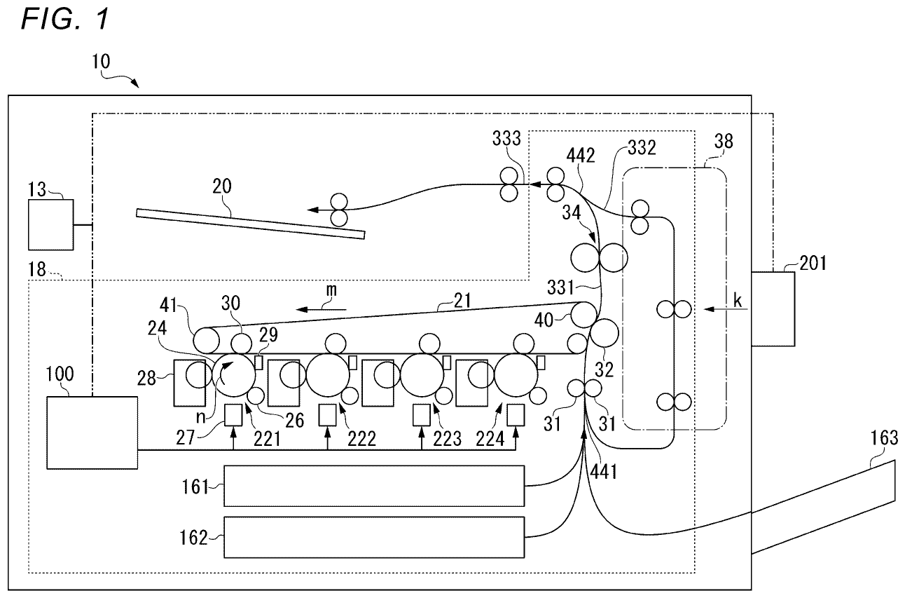

FIG. 1 is a diagram illustrating an example of an image forming device 10 according to an embodiment. The image forming device 10 is an example of a sheet processing device.

In FIG. 1, the image forming device 10 includes a control panel 13, a wireless tag communication device 201, and a printer unit 18. The printer unit 18 includes a control unit 100, paper feeding cassettes 161 and 162, and the like. The control unit 100 (e.g., controller) controls the control panel 13, the wireless tag communication device 201, and the printer unit 18. The control unit 100 controls the conveyance of the sheet in the printer unit 18. As used herein “controlling sheet conveyance” and like terms means controlling the timing of sheet conveyance, a stop position of the sheet, a conveyance speed of the sheet, and the like.

The control panel 13 includes an input key and a display unit. For example, the input key receives input by a user. For example, the display unit is a touch panel type unit (e.g., a touch sensitive display). The display unit receives input from the user and displays the input to the user. For example, the control panel 13 displays items related to the operation of the image forming device 10 on the display unit in a configurable manner. The control panel 13 notifies the control unit 100 of the items set/selected by the user.

The paper feeding cassettes 161 and 162 store sheets on which wireless tags are provided. Of course, the paper feeding cassettes 161 and 162 can also store sheets not provided with wireless tags. In the following description, unless otherwise specified, the sheet is a sheet provided with a wireless tag. The sheet is made of a material such as paper or plastic film.

The printer unit 18 performs image formation operations. For example, the printer unit 18 forms an image represented by image data on a sheet. In the following description, forming an image on the sheet is also referred to as printing. The printer unit 18 includes an intermediate transfer belt 21. The printer unit 18 supports the intermediate transfer belt 21 with a driven roller 41, a backup roller 40, and the like. The printer unit 18 rotates the intermediate transfer belt 21 in the direction of an arrow m.

The printer unit 18 includes four sets of image forming stations 221, 222, 223, and 224. The image forming stations 221, 222, 223, and 224 are for forming images of Y (yellow), M (magenta), C (cyan), and K (black), respectively. The image forming stations 221, 222, 223, and 224 are disposed below the intermediate transfer belt 21 along a direction of rotation of the intermediate transfer belt 21.

Hereinafter, the image forming station 221 for Y (yellow) among the image forming stations 221, 222, 223, and 224 will be described as an example. Since the image forming stations 222, 223, and 224 have the same configuration as the image forming station 221, detailed description thereof will be omitted.

The image forming station 221 includes an electrostatic charger 26, an exposure scanning head 27, a developing device 28, and a photoconductor cleaner 29. The electrostatic charger 26, the exposure scanning head 27, the developing device 28, and the photoconductor cleaner 29 are arranged around a photoconductor drum 24 rotating in the direction of an arrow n.

The image forming station 221 includes primary transfer rollers 30. The primary transfer rollers 30 face the photoconductor drum 24 with the intermediate transfer belt 21 interposed therebetween.

The image forming station 221 charges the photoconductor drum 24 with the electrostatic charger 26 and then exposes the drum to light with the exposure scanning head 27. The image forming station 221 forms an electrostatic latent image on the photoconductor drum 24. The developing device 28 develops the electrostatic latent image on the photoconductor drum 24 using a two-component developer made of toner and carrier.

The primary transfer rollers 30 perform primary transfer of the toner image formed on the photoconductor drum 24 onto the intermediate transfer belt 21. The image forming stations 221, 222, 223, and 224 form a color toner image on the intermediate transfer belt 21 by the primary transfer rollers 30. The color toner image is formed by sequentially overlapping toner images of Y (yellow), M (magenta), C (cyan) and K (black). The photoconductor cleaner 29 removes the toner remaining on the photoconductor drum 24 after the primary transfer.

The printer unit 18 includes secondary transfer rollers 32. The secondary transfer rollers 32 face the backup roller 40 with the intermediate transfer belt 21 interposed therebetween. The secondary transfer rollers 32 secondarily transfer the color toner images on the intermediate transfer belt 21 to the sheet all at once. In the following description, the term “toner image” may refer to either a color toner image or a toner image of only one color. The toner image may be a toner image using a decolorizing toner.

A conveyance path 331 is a conveyance path from a junction 441 to a branch portion 442. A conveyance path 332 is a conveyance path that passes through a double-sided printing device 38 and is a conveyance path from the branch portion 442 to the junction 441. A conveyance path 333 is a conveyance path from the branch portion 442 to a discharge tray 20.

A tip end of a sheet picked up from the paper feeding cassette 161, the paper feeding cassette 162, or a manual feed tray 163 is abutted against a portion where the two registration rollers 31 are in contact with each other while the two rollers are stopped. The sheet that is struck against the registration roller 31 has its inclination corrected. The control unit 100 starts the rotation of the registration rollers 31 in accordance with a position of the toner image on the rotating intermediate transfer belt 21 and moves the sheet to a position of the secondary transfer rollers 32. The control unit 100 controls the secondary transfer rollers 32 to secondarily transfer the toner image formed on the intermediate transfer belt 21 onto the sheet. The control unit 100 conveys the sheet to the conveyance path 331 and forms an image by fixing the toner image on the sheet by a fixing device 34. The control unit 100 conveys the sheet on which the image is formed to the conveyance path 333, and then discharges the sheet.

In a case of double-sided printing, the control unit 100 conveys the sheet on which an image is formed on the front side to the conveyance path 333. After the entire sheet passes through the branch portion 442, the control unit 100 switches back and conveys the sheet to the conveyance path 332. Thereafter, the control unit 100 conveys the sheet to the junction 441 via the conveyance path in the double-sided printing device 38 and conveys the sheet to the conveyance path 331 via the registration rollers 31. The control unit 100 then fixes the toner image by the fixing device 34 to form an image on the back side of the sheet. The control unit 100 conveys the sheet having the image formed on the back side to the conveyance path 333, and then discharges the sheet.

The wireless tag communication device 201 is capable of communicating with the control unit 100 (e.g., communicatively coupled with the control unit 100). The wireless tag communication device 201 communicates with the wireless tag of the sheet to read information from the wireless tag and write information to the wireless tag. The wireless tag communication device 201 transmits a signal in a direction of an arrow k. The signal is specifically a modulated radio wave. Information is written to the wireless tag of the sheet by the signal transmitted from the wireless tag communication device 201.

The image to be formed in the printer unit 18 is formed on the photoconductor drum 24 as an electrostatic latent image from the exposure scanning head 27 before being secondarily transferred to the secondary transfer rollers 32. The electrostatic latent image formed on the photoconductor drum 24 is primarily transferred to the intermediate transfer belt 21 as a toner image. Furthermore, the toner image primarily transferred onto the intermediate transfer belt 21 is secondarily transferred onto the wireless tag sheet conveyed to the position of the registration rollers 31.

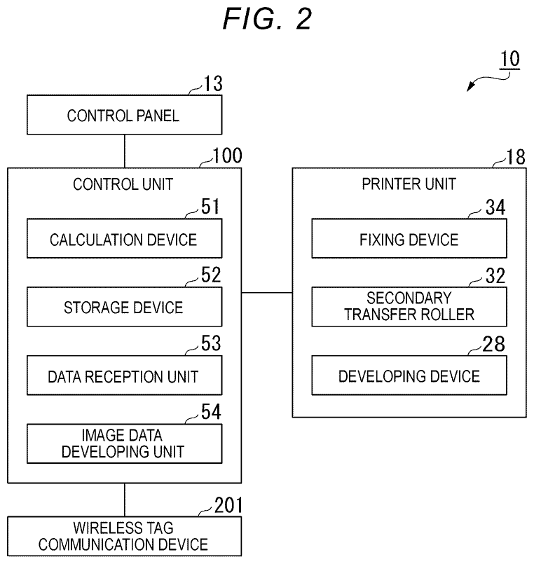

Next, a functional block diagram of the image forming device according to the embodiment will be described with reference to FIG. 2. In FIG. 2, the image forming device 10 includes the control unit 100, the control panel 13, the printer unit 18, and the wireless tag communication device 201.

The control unit 100 includes a calculation device 51 (e.g., a processor, processing unit, etc.) and a storage device 52 (e.g., memory, memory device, etc.). The calculation device 51 controls the control panel 13, the printer unit 18, and the wireless tag communication device 201 according to an image processing program stored in the storage device 52. The control unit 100 outputs, for example, information indicating that the conveyance of the sheet is started (hereinafter, referred to as “conveyance start information”).

The calculation device 51 is, for example, a central processing unit (CPU), an application specific integrated circuit (ASIC), or the like. The storage device 52 is a read only memory (ROM), a random access memory (RAM), a hard disk drive (HDD), a solid state drive (SSD), or the like. A data reception unit 53 (e.g., a communication interface) receives print data (for example, data written in a page description language) indicating an image to be printed from a host such as a personal computer (PC) and stores the received print data in the storage device 52. An image data developing unit 54 determines printing conditions from the print data stored in the storage device 52 by the data reception unit 53, and develops the data into printable data (e.g., raster data) for the printer unit 18 to store in the storage device 52.

The printer unit 18 includes the fixing device 34, the secondary transfer rollers 32, and the developing device 28. The printer unit 18 forms an image on a sheet based on the data stored in the storage device 52 by the image data developing unit 54.

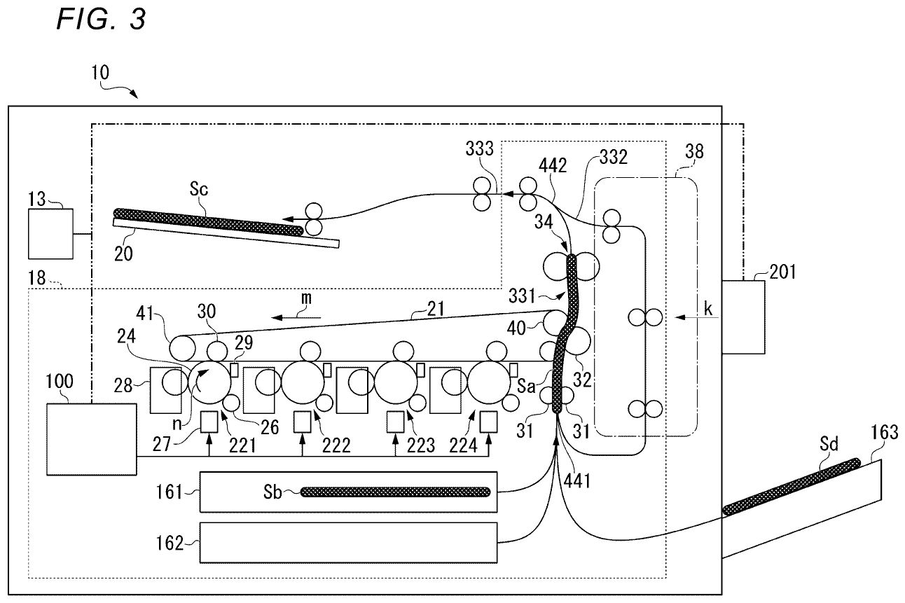

FIG. 3 is a diagram illustrating an example of a position where a sheet is capable of being present in the image forming device 10 of the embodiment. In FIG. 3, a sheet Sb indicates a sheet placed on the paper feeding cassette 161. A sheet Sc indicates a sheet placed on the discharge tray 20. A sheet Sd indicates a sheet placed on the manual feed tray 163. The paper feeding cassettes 161 and 162, the discharge tray 20, and the manual feed tray 163 are examples of a placement unit.

A sheet Sa indicates a sheet being conveyed along the conveyance path 331. Each sheet is provided with a wireless tag.

In FIG. 3, the sheet on which information is to be written to the wireless tag (hereinafter, also referred to as the “target sheet”) is a sheet being conveyed along the conveyance path 331. Therefore, the sheet Sa is an example of a target sheet.

In the state illustrated in FIG. 3, the wireless tag communication device 201 transmits a signal in the direction of the arrow k. That is, the k direction is the transmission direction of the signal transmitted by the wireless tag communication device 201. Therefore, the k direction is also a propagation direction of the radio waves emitted by the wireless tag communication device 201.

Each wireless tag that receives a signal performs an action according to the content of the received signal. The wireless tag stores information indicated by the received signal, for example. The wireless tag responds to, for example, the wireless tag communication device 201. Responding specifically means sending a signal. The wireless tag communication device 201 receives a signal transmitted from the wireless tag provided on each sheet. In the case of FIG. 3, one of the wireless tags that receives the signal is the wireless tag provided on the sheet Sa. In FIG. 3, the sheet Sa is being conveyed.

The wireless tag has a shape having a major axis and a minor axis in a plane perpendicular to the k direction, and when the wavelength of the radio wave is the same, the wireless tag interacts more strongly with a polarized wave whose polarization plane is parallel to the major axis than with a polarized wave whose polarization plane is perpendicular to the major axis. Strong interaction means that there is a low probability that the radio waves will penetrate the wireless tag, and there is a high probability that the radio waves that reach the wireless tag will be absorbed or reflected by the wireless tag. Therefore, it is preferable for the wireless tag communication device 201 to use radio waves whose polarization plane is parallel to the major axis of the wireless tag in order to exchange information with the wireless tag, from the viewpoint of power consumption and low frequency of communication errors. The occurrence of the communication errors means that information cannot be exchanged between the wireless tag communication device 201 and the wireless tag.

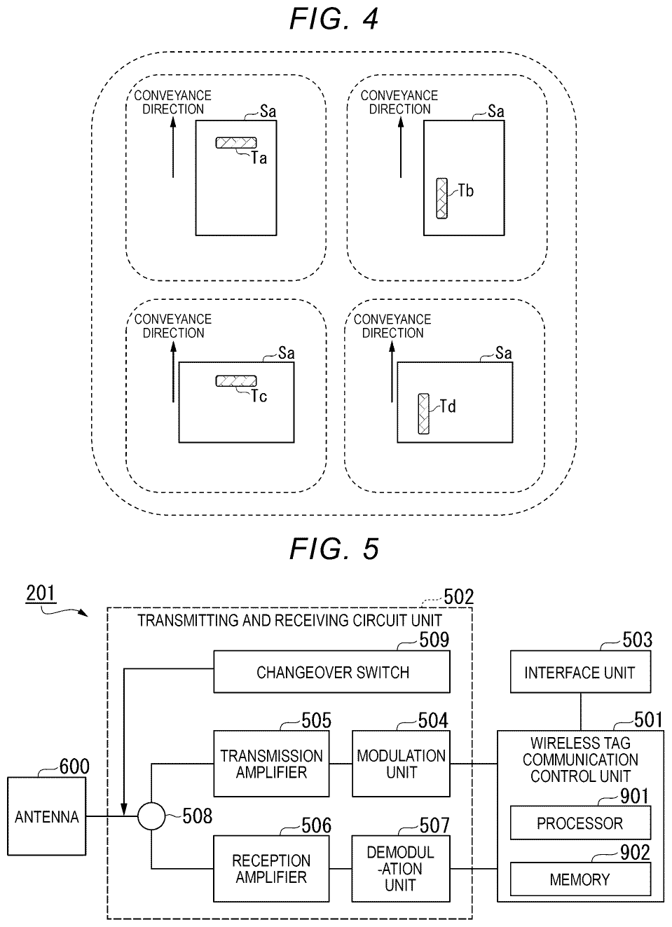

FIG. 4 is a diagram illustrating an example of the relationship between the arrangement of wireless tags on a sheet and the conveyance direction of the sheet in the embodiment. In FIG. 4, tags Ta, Tb, Tc, and Td are examples of wireless tags provided on the sheet Sa being conveyed through the conveyance path 331. The tag Ta is an example of a wireless tag that is provided on the sheet Sa so that the major axis is perpendicular to the conveyance direction and perpendicular to the major axis direction of the sheet surface. The tag Tb is an example of the wireless tag that is provided on the sheet Sa such that the major axis is parallel to the conveyance direction and parallel to the major axis of the sheet Sa. The tag Tc is an example of the wireless tag that is provided on the sheet Sa such that the major axis is perpendicular to the conveyance direction and parallel to the major axis of the sheet Sa. The tag Td is an example of the wireless tag that is provided on the sheet Sa such that the major axis is parallel to the conveyance direction and perpendicular to the major axis of the sheet Sa. Although FIG. 4 illustrates an example in which one wireless tag is disposed on one sheet, it is not necessary to dispose only one wireless tag on one sheet, and multiple wireless tags may be disposed on one sheet.

The conveyance direction of the sheet is, for example, a direction perpendicular to the k direction in FIG. 3 and is a direction from bottom to top on the sheet surface of FIG. 3. In addition, since the wireless tag is attached to the sheet, the conveyance direction of the sheet is also the conveyance direction of the wireless tag.

FIG. 5 is a diagram illustrating an example of the configuration of the wireless tag communication device 201 according to the embodiment. The wireless tag communication device 201 includes an antenna 600, a wireless tag communication control unit 501, a transmitting and receiving circuit unit 502, and an interface unit 503.

The antenna 600 transmits a signal. The antenna 600 receives an incoming signal. A carrier of the signal transmitted by the antenna 600 is radio waves. A carrier of the signal received by the antenna 600 is radio waves.

The wireless tag communication control unit 501 is configured using a processor 901 such as a CPU and a memory 902. The wireless tag communication control unit 501 operates by the processor 901 reading a program stored in the memory 902 and executing the read program. The wireless tag communication control unit 501 controls the operation of each functional unit included in the wireless tag communication device 201. A write threshold is stored in advance in the memory 902.

The wireless tag communication control unit 501 receives, for example, the sheet conveyance start information. The wireless tag communication control unit 501 controls the operation of each functional unit included in the wireless tag communication device 201 to cause the wireless tag communication device 201 to transmit a signal. The wireless tag communication control unit 501 demodulates a signal received by the antenna 600 by controlling the operation of each functional unit included in the wireless tag communication device 201, for example. The wireless tag communication control unit 501 measures the elapsed time after receiving the conveyance start information, for example.

The transmitting and receiving circuit unit 502 includes a modulation unit 504, a transmission amplifier 505, a reception amplifier 506, a demodulation unit 507, a circulator 508, and a changeover switch 509.

The modulation unit 504 modulates the radio waves emitted by the wireless tag communication device 201. More specifically, a voltage modulated by the control of the wireless tag communication control unit 501 is applied to the modulation unit 504, and the application of the voltage causes the modulation unit 504 to generate a modulated current. The current generated by the modulation unit 504 flows through the transmission amplifier 505, and then the antenna 600 generates radio waves. The radio waves generated by the antenna 600 are the radio waves emitted by the wireless tag communication device 201. In this way, the radio waves modulated by the modulation unit 504 is the radio waves emitted from the antenna 600, and therefore, the radio waves modulated by the modulation unit 504 is the signal transmitted by the wireless tag communication device 201.

The transmission amplifier 505 controls the strength of the signal transmitted by the wireless tag communication device 201. The circulator 508 separates the signal transmitted by the antenna 600 from the signal received by the antenna 600.

The changeover switch 509 switches the application destination of the voltage (that is, the target to which the current modulated by the modulation unit 504 and amplified by the transmission amplifier 505 flows). Specifically, the changeover switch 509 switches the connection destination of the transmission amplifier 505 to one of feeders 641 and 642 described later. The changeover switch 509 is, for example, a radio frequency (RF) switch such as a single-pole double-throw switch. The operation of the changeover switch 509 is controlled by the wireless tag communication control unit 501. The changeover switch 509 is operated under the control of the wireless tag communication control unit 501, and the voltage application destination is switched.

The reception amplifier 506 controls the strength of the signal received by the antenna 600 to a predetermined strength. The demodulation unit 507 demodulates the signal received by the antenna 600.

The interface unit 503 is an interface that electrically connects the wireless tag communication control unit 501 and the control unit 100.

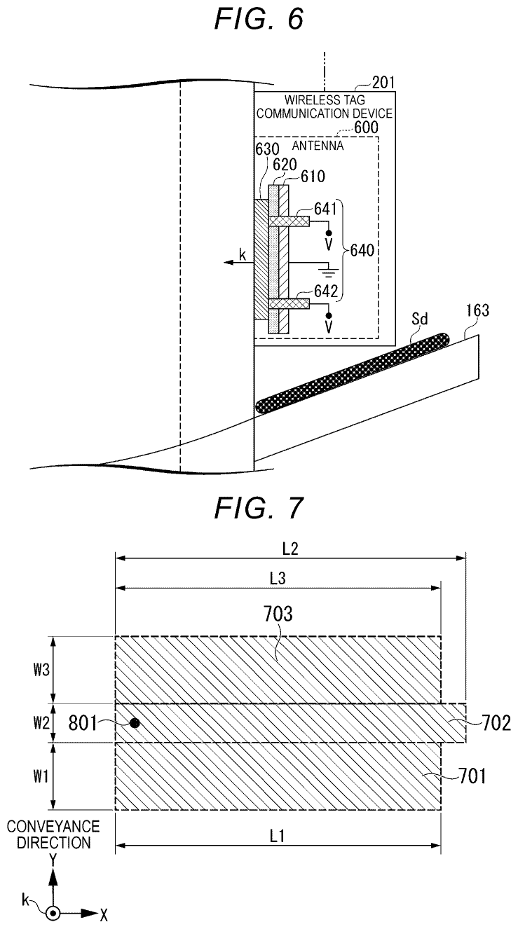

FIG. 6 is a diagram illustrating an example of a side view of a configuration of the antenna 600 according to the embodiment. The antenna 600 is a microstrip antenna including a ground conductor plate 610, a dielectric substrate 620, and a radiating element 630. The ground conductor plate 610 is a ground conductor. The dielectric substrate 620 is a dielectric material that is in contact with the ground conductor plate 610.

The radiating element 630 is a conductor located on the side opposite to the ground conductor plate 610 with the dielectric substrate 620 interposed therebetween and is a conductor in contact with the dielectric substrate 620. The radiating element 630 is connected to the feeders 641 and 642 that pass through the dielectric substrate 620 and the ground conductor plate 610. The feeders 641 and 642 are conductors. When a voltage is applied to the radiating element 630 via either the feeder 641 or 642, the radiating element 630 emits radio waves generated by the current generated by the applied voltage. The emitted radio waves are the signal. The wave vector of the radio waves emitted by the radiating element 630 is a vector pointing in the k direction. Hereinafter, when there is no distinction between the feeder 641 and the feeder 642, it will be referred to as a feeder 640. The end of the feeder 640 that is not in contact with the radiating element 630 is connected to the changeover switch 509.

For the sake of simplicity, a plane perpendicular to the k direction is referred to as an XY plane. Hereinafter, of the two mutually orthogonal vectors that span the XY plane, the vector perpendicular to the conveyance direction of the sheet conveyed on the conveyance path 331 is referred to as an X vector, and the vector perpendicular to the X vector is referred to as a Y vector.

The shape of the surface of the radiating element 630 perpendicular to the k direction is substantially the same regardless of the position in the k direction. The length of the radiating element 630 in the k direction is preferably shorter than the wavelength of the radio waves emitted by the radiating element 630, and particularly preferably a length less than ¼ of the wavelength.

FIG. 7 is an explanatory diagram illustrating an example of a shape of the radiating element 630 in the XY plane (hereinafter, referred to as the “radiating element shape”) in the embodiment. The direction perpendicular to the sheet surface of FIG. 7 is parallel to the k direction.

The surface surrounded by the radiating element shape (hereinafter, referred to as the “radiating element surface”) has a first radiation area, a second radiation area, and a third radiation area. That is, the first radiation area, the second radiation area, and the third radiation area are located in the same plane. The first radiation area, the second radiation area, and the third radiation area are areas having a major axis and a minor axis perpendicular to the major axis.

The first radiation area and the second radiation area satisfy a major axis condition, a minor axis condition, and a direction condition. The major axis condition is a condition that a second major axis which is a major axis of the second radiation area is longer than a first major axis which is a major axis of the first radiation area. The minor axis condition is a condition that the second minor axis which is a minor axis of the second radiation area is shorter than the first minor axis which is a minor axis of the first radiation area. The direction condition is a condition that the first major axis and the second major axis are parallel.

In FIG. 7, the first radiation area is an area 701. In FIG. 7, the second radiation area is an area 702. In FIG. 7, the third radiation area is an area 703. Therefore, in the example of FIG. 7, the first major axis, the second major axis, and a third major axis, which is the major axis of the third radiation area, are parallel to the X axis. In the example of FIG. 7, the first minor axis, the second minor axis, and a third minor axis, which is the minor axis of the third radiation area, are parallel to the Y axis.

In FIG. 7, a feeding point 801 located within the area 702 is a feeding point. The area 701 borders the area 702. The area 702 borders the area 701 and the area 703. The area 702 borders the area 703. Therefore, an electrical signal applied to the feeding point 801 flows into the areas 701, 702, and 703.

In the example of FIG. 7, the shapes of area 701, area 702, and area 703 are rectangles, which are a type of shape having a major axis and a minor axis. However, the shapes of the first radiation area, the second radiation area, and the third radiation area are not necessarily limited to rectangles as long as they have major and minor axes. The shape may be, for example, an ellipse.

For the sake of simplicity, the length of the first major axis is represented as L1, the length of the first minor axis is represented as W1, the length of the second major axis is represented as L2, the length of the second minor axis is represented as W2, the length of the third major axis is represented as L3, and the length of the third minor axis is represented as W3. In the example of FIG. 7, L1=L3<L2, and W1=W3>W2.

Since the first radiation area has the major axis length L1, the first radiation area resonates with a signal having a wavelength equal to twice the length L1. Therefore, the resonant frequency of the first radiation area is the reciprocal of twice L1. Since the second radiation area has the major axis length L2, the second radiation area resonates with a signal having a wavelength equal to twice the length L2. Therefore, the resonant frequency of the second radiation area is the reciprocal of twice L2. Since the third radiation area has the major axis length L3, the third radiation area resonates with a signal having a wavelength equal to twice the length L3. Therefore, the resonant frequency of the third radiation area is the reciprocal of twice L3.

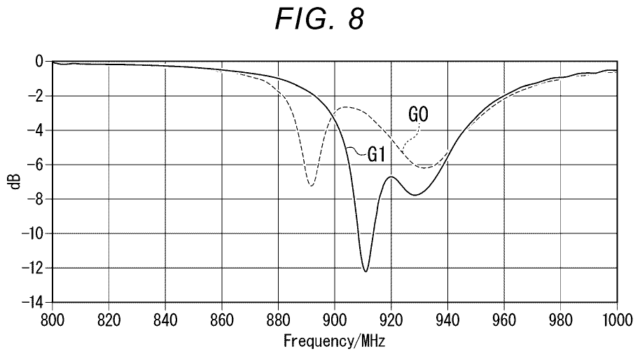

FIG. 8 is a diagram illustrating an example of a result of an experiment using the antenna 600 including the radiating element 630 according to the embodiment. More specifically, FIG. 8 is a diagram illustrating an example of the results of measuring S11 for the antenna 600 (hereinafter, referred to as “first Kawasaki antenna”) provided with the radiating element 630 of FIG. 7. In the experiment, lengths of the radiating elements 630 of the first Kawasaki antenna were L1=L3 =75 mm, L2=75.8 mm, W1=W3=29 mm, and W2=15 mm.

A horizontal axis represents frequency, and a vertical axis represents S11. Therefore, the higher the efficiency of the conversion of the electrical signal injected into the antenna 600 into the radio waves, the larger the negative value on the vertical axis will be. In the experiment, the dielectric constant of the dielectric substrate 620 was 4.6, and the radiating element 630 was made of copper and had a conductivity of 5.8*10⁷ [S/m].

In FIG. 8, a graph G1 shows the results for the first Kawasaki antenna, and a graph G0 shows the results for an antenna to be compared. The antenna to be compared was different from the first Kawasaki antenna in that the antenna to be compared did not satisfy the minor axis condition and that W1=W3=15 mm.

The graph G1 shows peaks near frequencies of 910 MHz and 930 MHz. Since the signal with frequency 910 MHz has a longer wavelength than the signal with frequency 930 MHz, the peak near the frequency of 910 MHz is caused by the existence of the second radiation area of the first Kawasaki antenna. In addition, the peak near the frequency of 930 MHz is caused by the existence of the first and third radiation areas of the first Kawasaki antenna.

The results of FIG. 8 show that the S11 of the first Kawasaki antenna has a peak near the frequency of 910 MHz that is lower than any of the peaks shown in graph G0. Therefore, the results in FIG. 8 show that the first Kawasaki antenna was able to improve the efficiency of energy conversion from electrical signals to radio waves compared to the antennas to be compared.

The difference between the first Kawasaki antenna and the antennas to be compared is that the length of the minor axis is uniform or non-uniform. More specifically, the lengths of the minor axes of the antennas to be compared are the same regardless of the areas, but the second minor axis of the first Kawasaki antenna is shorter than the first and third minor axes. This difference results in more efficiency of energy conversion from the electrical signals into the radio waves.

In the example of FIG. 7, there are three areas, the first radiation area, the second radiation area, and the third radiation area. However, it is not necessary that there are three areas. If there exist the first radiation area and the second radiation area that satisfy the major axis condition, the minor axis condition, and the direction condition, the efficiency of energy conversion from the electrical signal to the radio waves is improved.

The antenna 600 thus configured includes the radiating element 630 including the first radiation area and the second radiation area that satisfy the major axis condition, the minor axis condition, and the direction condition. Therefore, as experimental results indicate, the efficiency of energy conversion from the electrical signal to the radio waves can be improved.

In addition, since the wireless tag communication device 201 thus configured includes the antenna 600, the efficiency of energy conversion from the electrical signal to the radio waves can be improved. In addition, since the image forming device 10 thus configured includes the antenna 600, the efficiency of energy conversion from the electrical signal to the radio waves can be improved. This is not limited to the image forming device 10, but also applies to other sheet processing device provided with the wireless tag communication device 201.

Other sheet processing devices include, for example, barcode printers used for managing incoming and outgoing goods, and reading devices attached to goods in retail stores such as apparel stores. In this case, the sheet provided with the wireless tag is the sheet that is attached to the item.

### Modification

Note that one end in a direction parallel to the first major axis and one end in a direction parallel to the second major axis do not necessarily have to be located on the same axis (that is, the ends do not necessarily have to be aligned) as illustrated in FIG. 7. This is true not only for the first and second major axes, but also for the third major axis. However, having aligned ends has the effect of providing a higher gain. If the ends are not aligned, the radiation area will have more sides and the power will be dispersed. Therefore, when the ends are not aligned, less power flows along the major axis direction than when the ends are aligned. As mentioned above, since the first to third radiation areas radiate radio waves with a resonant frequency determined by the length of the major axis, the more power that flows along the major axis, the higher the gain. Therefore, the ends are more preferable to be aligned than not to be aligned.

In addition, it is desirable that the distance between the first radiation area to the third radiation area is within a few millimeters. By being within a few millimeters of each other, the same amount of power flows through each area, and the corresponding resonant frequencies can be obtained simultaneously. Therefore, a wide range of bandwidth can be handled.

Note that the length of the third major axis does not necessarily have to be the same as the length of the first major axis. The third major axis may be a major axis parallel to the first major axis and may have a length different from at least one of the lengths of the first major axis and the second major axis.

Also, the length of the third minor axis does not necessarily have to be the same as the length of the first minor axis. Thus, for example, the length of the third major axis may be the same as the length of the second major axis, and the length of the third minor axis may be the same as the length of the second minor axis. In addition, the length of the third major axis may be shorter than the length of the first major axis, and the length of the third minor axis may be longer than the length of the first minor axis. In addition, the length of the third major axis may be longer than the length of the second major axis, and the length of the third minor axis may be shorter than the length of the second minor axis. In addition, the length of the third major axis may be longer than the length of the first major axis and shorter than the length of the second major axis, and the length of the third minor axis may be shorter than the length of the first minor axis and longer than the length of the second minor axis.

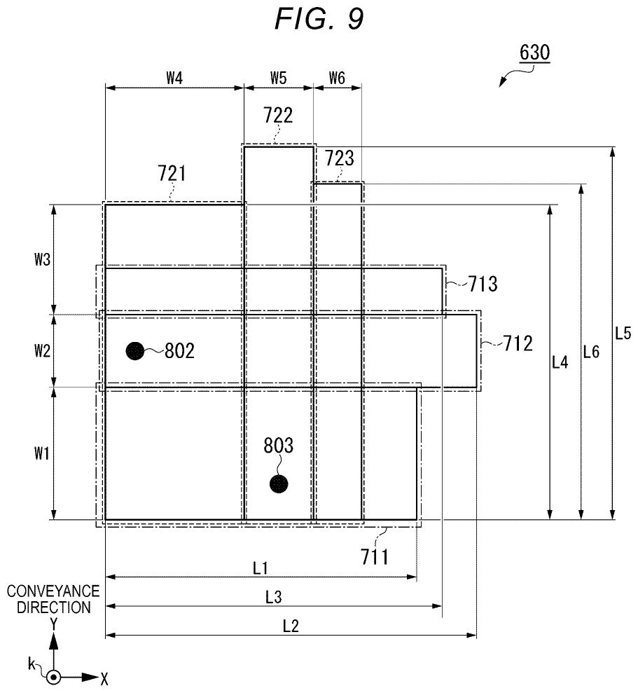

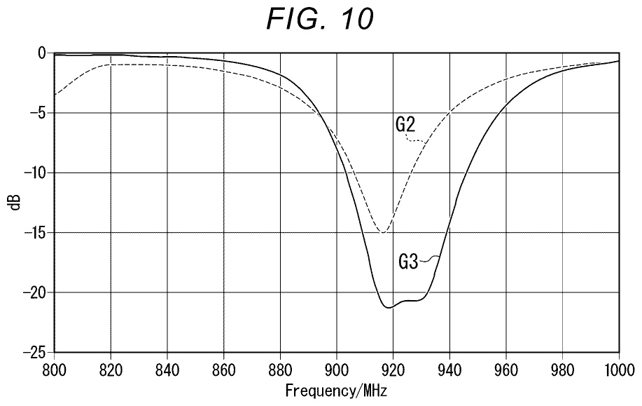

FIG. 9 is an explanatory diagram illustrating an example of a radiating element shape of a radiating element 630 in a modification. The direction perpendicular to the sheet surface of FIG. 9 is parallel to the k direction. The radiating element 630 of FIG. 9 further includes a fourth radiation area, a fifth radiation area, and a sixth radiation area in addition to the first radiation area, the second radiation area, and the third radiation area.

The fourth radiation area includes a fourth minor axis that is a minor axis parallel to the first major axis, and a fourth major axis that is a major axis perpendicular to the fourth minor axis. A part of the fourth radiation area is common to a part of the first radiation area. Another part of the fourth radiation area is common to a part of the second radiation area.

The fifth radiation area includes a fifth minor axis that is a minor axis parallel to the first major axis and shorter than the fourth minor axis, and a fifth major axis that is a major axis perpendicular to the fifth minor axis. A part of the fifth radiation area is common to a part of the first radiation area that is not common to the fourth radiation area. Another part of the fifth radiation area is common to a part of the second radiation area that is not common to the fourth radiation area.

The sixth radiation area includes a sixth minor axis that is a minor axis parallel to the first major axis and a sixth major axis that is a major axis perpendicular to the sixth minor axis. A part of the sixth radiation area is common to a part of the first radiation area that is not common to the fourth radiation area and the fifth radiation area. Another part of the sixth radiation area is common to a part of the second radiation area that is not common to the fourth radiation area and the fifth radiation area.

In FIG. 9, an area 711 is the first radiation area, an area 712 is the second radiation area, an area 713 is the third radiation area, an area 721 is the fourth radiation area, an area 722 is the fifth radiation area, and an area 723 is the sixth radiation area. The area 711 and the area 712 satisfy the major axis condition, the minor axis condition, and the direction condition. FIG. 9 illustrates that the areas 721, 722, and 723 conform to the above definitions of the fourth radiation area, the fifth radiation area, and the sixth radiation area, respectively. In FIG. 9, a feeding point 802 and a feeding point 803 are examples of the feeding points.

The fifth major axis may be shorter than the fourth major axis, but as illustrated in the example of FIG. 9, the fifth major axis may be longer than the fourth major axis.

FIG. 10 is a diagram illustrating an example of a result of an experiment using the antenna 600 including the radiating element 630 according to the modification. More specifically, FIG. 10 is a diagram illustrating an example of the results of measuring S11 for the antenna 600 (hereinafter, referred to as “second Kawasaki antenna”) provided with the radiating element 630 of FIG. 9. In the experiment, lengths of the radiating elements 630 of the second Kawasaki antenna were L1=67 mm, L2=80 mm, L3=72 mm, W1=29 mm, W2=15 mm, and W3=10 mm. In addition, the length L4 of the fourth major axis was 67 mm, the length W4 of the fourth minor axis was 29 mm, the length L5 of the fifth major axis was 80 mm, the length W5 of the fifth minor axis was 15 mm, the length L6 of the sixth major axis was 72 mm, and the length W6 of the sixth minor axis was 10 mm.

A horizontal axis represents frequency, and a vertical axis represents S11. Also in the experiment that gave the results of FIG. 10, the dielectric constant of the dielectric substrate 620 was 4.6, and the radiating element 630 was made of copper and had a conductivity of 5.8□107 [S/m].

In FIG. 10, a graph G3 shows the results for the second Kawasaki antenna, and a graph G2 shows the results for an antenna to be compared. The antenna to be compared was different from the second Kawasaki antenna in that the antenna to be compared did not satisfy the minor axis condition and that W1=W3=15 mm.

The results of FIG. 10 show that the S11 of the second Kawasaki antenna has a peak near the frequency of 920 MHz that is lower than any of the peaks shown in graph G3. Therefore, the results in FIG. 10 show that the second Kawasaki antenna was able to improve the efficiency of energy conversion from electrical signals to radio waves compared to the antennas to be compared.

The difference between the second Kawasaki antenna and the antennas to be compared is whether the minor axis condition is satisfied or not. More specifically, the antennas to be compared do not satisfy the minor axis condition, but the second Kawasaki antenna satisfies the minor axis condition. This difference results in more efficiency of energy conversion from the electrical signals into the radio waves.

In the example of FIG. 10, there are six areas, the first radiation area to the sixth radiation area, but it is not necessary that there are six areas. The first radiation area and the second radiation area are preferably present, and for example, the fourth radiation area or the fifth radiation area may also be present.

Note that one end in a direction parallel to the major axis of the third radiation area and one end in a direction parallel to the major axis of the fourth radiation area do not necessarily have to be located on the same axis (that is, the ends do not necessarily have to be aligned) as illustrated in FIG. 9. This is true not only for the third radiation area and the fourth radiation area, but also the fifth radiation area and the sixth radiation area. However, having aligned ends has the effect of providing a higher gain. If the ends are not aligned, the radiation area will have more sides and the power will be dispersed. Therefore, when the ends are not aligned, less power flows along the major axis direction than when the ends are aligned. As mentioned above, since the radiation portion emits radio waves at a resonant frequency determined by the length of the major axis in the major axis direction, the more power that flows in the major axis direction, the higher the gain. Therefore, the ends are more preferable to be aligned than not to be aligned.

The direction of the first major axis does not necessarily have to be perpendicular to the sheet conveyance direction but may be parallel thereto. Furthermore, the direction of the first major axis does not necessarily have to be perpendicular or parallel to the conveyance direction of the sheet. The direction of the first major axis may be perpendicular or parallel to a direction that forms a predetermined angle with the conveyance direction of the sheet (hereinafter, referred to as the “reference direction”). For example, an X-axis direction in FIGS. 7 and 9 may be perpendicular to the reference direction, and a Y-axis direction in FIGS. 7 and 9 may be parallel to the reference direction.

In addition, whether the wireless tag communication device 201 uses the feeder 641 or 642 to exchange information with the wireless tag when the wireless tag communication device 201 is in use may be determined in advance by the user or may be determined by the wireless tag communication device 201 executing a predetermined process. In the case where the user makes a decision in advance, for example, the user determines to use the feeder 640 that emits polarized waves with a polarization plane parallel to the direction of the wireless tag on the sheet to be processed for information exchange.

When the wireless tag communication device 201 makes a determination, the predetermined process is, for example, the following determination process. In the determination process, first, under the control of the wireless tag communication control unit 501, the feeder 640 to which the voltage is applied is switched at a predetermined cycle before information is exchanged with the wireless tag. Each time the switch is made, the radio waves are emitted and the strength of the reflected waves of the radio waves by the wireless tag is measured. The timing of switching is determined by the wireless tag communication control unit 501. The reflected waves are the radio waves emitted by the wireless tag. The reflected waves are measured by the wireless tag communication control unit 501. The wireless tag communication control unit 501 ends the switching process when the reflected waves of a predetermined strength or greater is observed. The wireless tag communication control unit 501 determines the feeder 640 to which the voltage was applied at the time when the switching is completed as the feeder 640 to be used for exchanging information with the wireless tag.

The transmitting and receiving circuit unit 502 is an example of a radiation control unit. The registration rollers 31 are an example of a conveyance member.

The antenna 600 is an example of a microstrip antenna. The X-axis direction, the Y-axis direction, the direction parallel to the reference direction, and the direction perpendicular to the reference direction are all examples of the first direction.

The functions of the image forming device 10 or the wireless tag communication control unit 501 in the above-described embodiment may be implemented by a computer. In this case, the function may be implemented by recording a program for implementing the function on a computer-readable recording medium, reading the program recorded on the recording medium into a computer system, and executing the program. In addition, the term “computer system” here includes hardware such as the OS and peripheral devices. In addition, “computer-readable recording medium” refers to portable media such as flexible disks, optical magnetic disks, ROMs, and CD-ROMs, as well as storage devices such as hard disks built into computer systems. Furthermore, the term “computer-readable recording medium” may also include a medium that dynamically stores a program for a short period of time, such as a communication line when transmitting the program via a network such as the Internet or a communication line such as a telephone line, and a medium that stores a program for a certain period of time, such as a volatile memory inside a computer system that is a server or client in such a case. The above program may be for implementing part of the above-mentioned functions or may be capable of implementing the above-mentioned functions in combination with a program already recorded in the computer system.

According to at least one of the embodiments described above, with the wireless tag communication device 201, it is possible to reduce the chances of being unable to exchange information with a wireless tag due to differences in the type of wireless tag.

While certain embodiments have been described, these embodiments have been presented by way of example only and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

The following discloses appendices relating to the above-mentioned embodiments.

### Appendix 1

A microstrip antenna including:
a radiating element that includes a first radiation area including a first major axis which is a major axis parallel to a first direction and a first minor axis which is a minor axis perpendicular to the first major axis, and a second radiation area including a second major axis which is a major axis parallel to the first direction and longer than the first major axis and a second minor axis which is a minor axis perpendicular to the second major axis,
in which a length of the second minor axis is shorter than a length of the first minor axis.

### Appendix 2

The microstrip antenna described in Appendix 1, further including:
a third radiation area including a third major axis which is a major axis parallel to the first direction and has a length different from at least one of a length of the first major axis and a length of the second major axis, and a third minor axis which is a minor axis perpendicular to the third major axis.

### Appendix 3

The microstrip antenna described in Appendix 2,
in which the length of the third major axis is equal to the length of the first major axis, and a length of the third minor axis is equal to the length of the first minor axis.

### Appendix 4

The microstrip antenna described in Appendix 2,
in which the length of the third major axis is equal to the length of the second major axis, and a length of the third minor axis is equal to the length of the second minor axis.

### Appendix 5

The microstrip antenna described in Appendix 2,
in which the length of the third major axis is shorter than the length of the first major axis, and a length of the third minor axis is longer than the length of the first minor axis.

### Appendix 6

The microstrip antenna described in Appendix 2,
in which the length of the third major axis is longer than the length of the second major axis, and a length of the third minor axis is shorter than the length of the second minor axis.

### Appendix 7

The microstrip antenna described in Appendix 2,
in which the length of the third major axis is longer than the length of the first major axis and shorter than the length of the second major axis, and a length of the third minor axis is shorter than the length of the first minor axis and longer than the length of the second minor axis.

### Appendix 8

The microstrip antenna described in any one of Appendices 1 to 7,
in which the radiating element includes a fourth radiation area including a fourth minor axis which is a minor axis parallel to the first direction and a fourth major axis which is a major axis perpendicular to the fourth minor axis,
a part of the fourth radiation area is common to a part of the first radiation area, and
another part of the fourth radiation area is common to a part of the second radiation area.

### Appendix 9

The microstrip antenna described in Appendix 8,
in which the radiating element further includes a fifth radiation area including a fifth minor axis which is a minor axis parallel to the first direction and shorter than the fourth minor axis, and a fifth major axis which is a major axis perpendicular to the fifth minor axis,
a part of the fifth radiation area is common to a part of the first radiation area that is not common to the fourth radiation area, and
another part of the fifth radiation area is common to a part of the second radiation area that is not common to the fourth radiation area.

### Appendix 10

The microstrip antenna described in Appendix 9,
in which the fifth major axis is longer than the fourth major axis.

### Appendix 11

A wireless tag communication device including:
a microstrip antenna, the antenna including a radiating element that includes a first radiation area including a first major axis which is a major axis parallel to a first direction and a first minor axis which is a minor axis perpendicular to the first major axis, and a second radiation area including a second major axis which is a major axis parallel to the first direction and longer than the first major axis and a second minor axis which is a minor axis perpendicular to the second major axis, in which a length of the second minor axis is shorter than a length of the first minor axis.

### Appendix 12

A sheet processing device including:
a conveyance member configured to convey a sheet; and
a wireless tag communication device including a microstrip antenna, the antenna including a radiating element that includes a first radiation area including a first major axis which is a major axis parallel to a first direction and a first minor axis which is a minor axis perpendicular to the first major axis, and a second radiation area including a second major axis which is a major axis parallel to the first direction and longer than the first major axis and a second minor axis which is a minor axis perpendicular to the second major axis, in which a length of the second minor axis is shorter than a length of the first minor axis.

What is claimed is:

1. A microstrip antenna comprising:
a radiating element that includes:
a first radiation area including a first major axis parallel to a first direction and a first minor axis perpendicular to the first major axis, and
a second radiation area including a second major axis parallel to the first direction and longer than the first major axis and a second minor axis perpendicular to the second major axis,
wherein the second minor axis is shorter than the first minor axis.

2. The microstrip antenna of claim 1, further comprising:
a third radiation area including:
a third major axis parallel to the first direction and has a length different from at least one of a length of the first major axis and a length of the second major axis, and
a third minor axis perpendicular to the third major axis.

3. The microstrip antenna of claim 1, wherein the radiating element includes:
a fourth radiation area including a fourth minor axis parallel to the first direction and a fourth major axis perpendicular to the fourth minor axis,
wherein a part of the fourth radiation area is common to a part of the first radiation area, and
wherein another part of the fourth radiation area is common to a part of the second radiation area.

4. A wireless tag communication device comprising:
a microstrip antenna, the microstrip antenna including a radiating element that includes:
a first radiation area including a first major axis which is a major axis parallel to a first direction and a first minor axis which is a minor axis perpendicular to the first major axis, and
a second radiation area including a second major axis which is a major axis parallel to the first direction and longer than the first major axis and a second minor axis which is a minor axis perpendicular to the second major axis, in which a length of the second minor axis is shorter than a length of the first minor axis.

5. The wireless tag communication device of claim 4, further comprising:
a third radiation area including:
a third major axis parallel to the first direction and has a length different from at least one of a length of the first major axis and a length of the second major axis, and
a third minor axis perpendicular to the third major axis.

6. The wireless tag communication device of claim 4, wherein the radiating element includes:
a fourth radiation area including a fourth minor axis parallel to the first direction and a fourth major axis perpendicular to the fourth minor axis,
wherein a part of the fourth radiation area is common to a part of the first radiation area, and
wherein another part of the fourth radiation area is common to a part of the second radiation area.

7. A sheet processing device comprising:
a conveyance member configured to convey a sheet; and
a wireless tag communication device including a microstrip antenna, the microstrip antenna including:
a radiating element that includes a first radiation area including a first major axis parallel to a first direction and a first minor axis perpendicular to the first major axis, and
a second radiation area including a second major axis parallel to the first direction and longer than the first major axis and a second minor axis perpendicular to the second major axis, wherein the second minor axis is shorter than the first minor axis.

8. The sheet processing device of claim 7, further comprising:
a third radiation area including:
a third major axis parallel to the first direction and has a length different from at least one of a length of the first major axis and a length of the second major axis, and
a third minor axis perpendicular to the third major axis.

9. The sheet processing device of claim 7, wherein the radiating element includes:
a fourth radiation area including a fourth minor axis parallel to the first direction and a fourth major axis perpendicular to the fourth minor axis,
wherein a part of the fourth radiation area is common to a part of the first radiation area, and
wherein another part of the fourth radiation area is common to a part of the second radiation area.

10. The sheet processing device of claim 7, wherein the sheet includes one or more wireless tags communicatively coupled with the wireless tag communication device.
